(19) United States
(12) Patent Application Publication
(10) Pub. No.: US 2002/0089442 A1
(43) Pub. Date: Jul. 11, 2002

(54) Method and apparatus for the deception of satellite navigation

(75) Inventors: Karl-Ragmar Riemschneider, Hamburg (DE); Franz Wolf, Hamburg (DE)

Correspondence Address: CHRISTIE, PARKER & HALE, LLP, 350 WEST COLORADO BOULEVARD, SUITE 500, PASADENA, CA, 91105, US

(73) Assignee: NAUTISCH-ELEKTRONISCHE TECHNIK

(21) Appl. No.: 10/044,389

(22) Filed: Jan. 11, 2002

Related U.S. Application Data
(63) Continuation of application No. 09/333,845, filed on Jun. 15, 1999, now Pat. No. 6,396,432.
(60) Provisional application No. 60/089,445, filed on Jun. 16, 1998.

(51) Int. Cl. G01S 7/38

(52) U.S. Cl. 342/15; 342/13; 342/14

(57) ABSTRACT

A method and apparatus for altering the coordinates obtained by satellite navigation in a receiving system which fixes an incorrect position, instead of a true position, within a given three-dimensional zone. In connection with altered coordinates, additional navigational information such as course and speed can also be influenced. Specifically, signals are received from a site and re-emitted in a suitable way so that a navigation receiver determines the position of the receiving site within the three-dimensional zone covered by the emission. This approach is superior to noise-blanketing countermeasures (such as carrier or noise interference) in that precise but untrue coordinates are determined in the navigation receiver, without this incorrectness being immediately recognized. In addition, advantages over code-producing deception measures are also gained in that no knowledge of the structure of the signal being emitted from the satellite is presupposed and thus any secrecy measures or modifications of this signal structure have no effect. Such embodiments may, for example, crucially reduce the effectiveness of weapons systems navigated by satellite or serve as deceptive measures in other applications concerned with security and weapons technology.

### CROSS-REFERENCE TO RELATED APPLICATION

The present application is a continuation of application Ser. No. 09/333,845, filed Jun. 15, 1999, which claims priority to provisional Application No. 60/089,445, filed Jun. 16, 1998. The priority of these applications is hereby claimed under 35 U.S.C. §§119(e), 120.

### FIELD

The present invention relates generally to satellite navigation, and more particularly, to a method and apparatus for altering the coordinates obtained by satellite navigation in a receiving system to fix an untrue position.

### BACKGROUND

Several satellite navigation systems are currently in operation and are being employed in numerous applications. Exemplary systems include the “GPS-Navstar” and “Glonass,” both which are particularly modern and precise. Moreover, new satellite navigation systems or extensions thereof are currently in the planning stage, e.g., the European system “ENSS.” With the assistance of these systems, position, speed and course can be determined with high precision and low cost with receiving and evaluating equipment (navigation receivers). The development of these high precision satellite navigation systems pose an immediate threat as navigation receivers are increasingly employed in weapons systems or used for other military purposes by a potential enemy.

Countermeasures for reducing the effectiveness of these threatening forces or weapons systems are known. Typically, they include eliminating the receiving power or manipulating the position-finding capability of the enemy's navigation receiver. The effectiveness cannot generally be restored, and if so, only through the use of other navigational methods in combination with the navigation receiver. Such substitute satellite navigation methods do not generally achieve comparable precision with similarly low cost.

Exemplary methods exist for eliminating reception capability by irradiating energy in the frequency bands of the satellite transmitters with jamming transmitters. Achieving the necessary reception field strengths for a limited area around the jamming transmitter dose not present a problem if the energy supply of the transmitter can be guaranteed. For example, unmodulated or noise-modulated jamming methods are possible. However, this approach generally exhibits lower efficiency than those that take into account the modulation method and the structure of the modulated satellite codes. Unfortunately, the use of satellite codes is only possible if information on these systems is available to one seeking to prevent satellite navigation. Therefore, as a precaution, satellite providers often use secret codes. This occurs, firstly, in order to prevent undesired use of the navigation system and, secondly, to make the possibility of interference with manipulation more difficult.

One precaution adopted by the manufacturers and users of the navigation systems is to check the integrity of the received signals. Hence, if the received signals cannot be evaluated, are contradictory or untrustworthy, use of the satellite navigation system will be suspended. In the case of simple jamming, without the use of the codes, this would generally be the case. Furthermore, received signals that cannot be evaluated often occur in terrain that is prone to multipath propagation or in sites that are partially shaded from radiation, or even conceivably in areas affected by local interference, without there being any deliberate attempt to jam. For these reasons, conventional automatic navigation systems are designed to bridge such situations when signals cannot be evaluated for a certain time, thereby rendering simple jamming techniques unacceptable in many countermeasure applications.

Conventional navigation receivers are also capable of suppressing simple interference even when the strength of the reception field of the interference signal is greater than that of the desired signal. For this purpose a so-called adaptive null steering of the antenna system can be applied, which assigns very low gain to one direction of the radiation pattern.

Increased reliability is achieved through common evaluation of different signals and frequency bands or by employing more than one satellite system for obtaining the navigational information. Only a slight advantage is achieved over deliberate jamming.

As a result of these conventional techniques employed in navigational systems, countermeasures for the effective hostile use of such systems face a number of problems.

First, when confronted by a simple jamming measure, a receiving system is not provided with a plausible received signal, and therefore, measures to protect the integrity may take effect.

Second, for reasons of secrecy or modifiability, the copying of satellite signal structure without the cooperation of the provider is only possible in the case of published civil codes. Generating replicas jointly with the satellite provider requires substantial logistic support and input in terms of maintaining secrecy as well as constant updating in accordance with the provider's agreement. This cannot always be guaranteed.

Third, the use of simple jamming methods can generally be counteracted with conventional means of radio reconnaissance if these reach the propagation range of the jamming signal.

Finally, direction-selecting precautions on the part of the hostile receiver, in particular, would be able to increase the jamming output required for simple interference to such an extent that an undesirably large area is affected by the interference and that the interference in turn becomes easier to counteract. Accordingly, there is a current need for a method and apparatus which, instead of preventing the satellite signal from being received or evaluated by simple jamming, strives to alter the position fixed by satellite navigation in enemy navigation receivers from the true coordinates obtained without detectable intervention.

### SUMMARY

The present invention is directed to a method and apparatus which satisfies this need. There is, therefore provided, in accordance with a preferred embodiment of the present invention, a system and method for deceiving a satellite navigation receiver. A receiving site includes a receiver which receives satellite signals sufficient to fix the position of the receiving site. An emission site with a transmitter receives the satellite signals from the receiver site and transmits them into a zone such that a navigation receiver, if it were located in the zone, would detect the position of the receiver site from the transmitted satellite signals.

This arrangement has a number of applications. By way of example, a target can be masked by locating the target within the zone so that a navigation receiver would not detect the presence of the target when the navigation receiver is in the zone. Alternatively, a pseudo target can be generated by locating the target at the receiving site so that the navigation receiver detects the presence of the target when the navigation receiver is within the zone created by the transmitter at the emission site away from the receiver site.

In an alternative embodiment, a number of receiver sites are employed. Each receiver site has a receiver for receiving satellite signals sufficient to fix the position of its respective receiving site. The received satellite signals from each receiver is transferred to a corresponding emission site where the signals are transmitted into a zone. As the navigation receiver advances through the zones established by the emission sites speed or course information is altered.

The described embodiments offer an attractive solution to simple jamming techniques in that a hostile navigation receiver is provided with a plausible signal, which despite integrity testing is recognized as trustworthy but nevertheless generates incorrect navigational information. “Manipulation,” defined herein as the simulation of untrue coordinates, enables a number of the enemy's precautions and integrity protection measures to be overcome.

Moreover, only a few, generally public or easy to acquire, parameters of the transmitting signal (frequency, bandwidth, approximate field strength) are required. No codes are needed. Manipulation is therefore possible without the provider's cooperation. The fact that the cooperation of the satellite provider is not required obviates the need for the aforementioned logistic input and dispenses with the problems of updating.

Another advantage of a preferred embodiment is that it generally requires less transmission power than simple jamming measures. For this reason and because of their signal structure they are more difficult to counteract.

In addition, if the null steering on the receiver's side is oriented away from a plausible incoming signal, then this protective measure can be overcome.

It is understood that other embodiments of the present invention will become readily apparent to those skilled in the art from the following detailed description, wherein it is shown and described only embodiments of the invention by way of illustration of the best modes contemplated for carrying out the invention. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### DESCRIPTION OF THE DRAWINGS

These and other features, aspects, and advantages of the present invention will become better understood with regard to the following description, appended claims, and accompanying drawings where:

FIG. 1 is a schematic representation of a preferred embodiment of the present invention;

FIG. 2 is a schematic representation of an application of a preferred embodiment of the present invention for generating pseudo-targets;

FIG. 3 is a schematic representation of an application of a preferred embodiment of the present invention for masking objects to be protected;

FIG. 4 is a schematic representation of a preferred embodiment of the present invention showing symmetrical and strongly asymmetrical arrangements of the emission environment;

FIG. 5 is a schematic representation of a preferred embodiment of the present invention having a field of zones for altering the speed or course of a navigation receiver viewed from above;

FIG. 6 is a schematic representation of a preferred embodiment of the present invention having a field of zones with symmetrical and strongly asymmetrical emission environments for altering the speed or course of a navigation receiver;

FIG. 7 is a schematic representation of a preferred embodiment of the present invention having a field of zones with symmetrical and strongly asymmetrical emission environments for altering the altitude a navigation receiver;

FIG. 8 is a schematic representation of a preferred embodiment of the present invention primarily intended for manipulating the altitude figures;

FIG. 9 is a schematic representation of a preferred embodiment of the present invention for manipulating surveying figures; and

FIG. 10 is a schematic representation of a preferred embodiment of the present invention that is switched between receiving sites.

### DETAILED DESCRIPTION

A preferred embodiment of the present invention is directed to a method and apparatus for altering the coordinates obtained by satellite navigation in a receiving system in such a way that an untrue position is fixed, instead of the correct one, within a certain three-dimensional zone. The described embodiments further extend to methods of radio navigation methods in which the role of transmitting satellites is partially or completely taken by other transmitter sites. Three basic procedural steps are involved. First a receiving system receives satellite signals that arrive at site A. Then the signals from site A are transferred to another site B. Finally the signals at site B are emitted into a certain three-dimensional zone C in a suitable manner. In this three-dimensional zone C around site B a navigation receiver will obtain the coordinates of site A, which do not agree with the true value.

Zone C may have a varying geometry and size. The expanse is determined by the transmitting power and the geometry of the antenna. Furthermore, the layout of the terrain has a particular influence on the expanse. A distinction can be made between an almost symmetrical area and a strong directional emphasis.

If there are no restrictions to the spreading, zone C is surrounded by a further zone in which the emitted signal interferes with the satellite signal at approximately the same strength. No precise geographical coordinates can be taken in this zone. The behavior of the receiving system in this interference zone is uncertain. The effective expanse of the inference zone depends, amongst other factors, upon the properties of the receiving system.

The transmission channel between site A and site B can be constructed in various ways. Conceivable methods include changing the frequency band compared with the original signal, coaxial lines, fiber-optic guides, radio relay links or digital transmission methods. The Doppler shift due to movement can be imitated by a slight change in the emitting frequency compared with the receiving frequency.

Repeated use of the proposed method in expansive areas can be particularly effective at distorting the obtainable navigation information. In this way, for example, untrue course corrections can be achieved which generate sufficient deviation for the intended purpose. For instance, one conceivable option would be to set up “manipulation fields” for the main incoming flight routes of enemy forces and resources.

If the receiving or transmitting sites are designed so that they can be switched, non-constant, false geographical information can be achieved within the zones affected by the emission. The same applies for variable zone size and alignment. This change can be interpreted by the receiving system to be perceived as movement, which would overcome an integrity check based on a minimum velocity criterion.

The common evaluation of different signals and frequency bands or the use of more than one satellite system for obtaining navigation information can be overcome by receiving, transmitting and emitting all the frequency bands employed.

The described embodiments of the present invention have numerous applications, some of which are discussed below. By way of example, manipulation can serve to protect important objects (so-called pinpoint targets) against means of reconnaissance and attack controlled by satellite navigation. For this purpose, in the context of object protection, a distinction has to be made between four general functional principles:

1. Generating pseudo targets, where signals are received close to a potential enemy target and are emitted in zones in which the intended effect will not be achieved. The expansion of a pinpoint target to a larger, surrounding pseudo target zone also reduces the hostile effect.

2. Masking the object with “irrelevant” site information; here untrue coordinates are generated in a zone around the potential enemy target so that precise arrival there is made difficult.

3. Distraction by means of erroneous course corrections during an advance or approach flight where influence is exerted on the navigation receiver at a site remote from the potential target in order to generate a severe deviation from a planned course. In this way it could be possible to prevent a target from being reached or enable a target to be more easily defended.

4. Generating surveying errors with the planning data for an enemy attack which will cause distorted information wherever it is generated by satellite navigation. This includes survey control of the launching site and the distortion of the coordinates in the reconnaissance information.

A particularly effective application pertains to the triggering of incorrect flight path corrections for terminally guided precision ballistic munitions without an independent drive in this final phase, since there is little flight time in reserve for remedial correction.

Another interesting application is against aircraft flying very low or landing if, for reasons of bad visibility and radar camouflage or radar countermeasures, satellite navigation is to be employed to determine the minimum flight altitude. If an incorrectly high altitude reading is simulated in such an aircraft or in a drone (‘beaming from above’), a further descent is induced and the probability of a ground collision increases. If an excessively low altitude is simulated (‘beaming from below’), an unwanted ascent will be achieved. In this way, for example, detection above the radar horizon of the air defense can occur, flight path error may be induced or landing can be prevented.

As in many other measures of deception, the effectiveness can be increased by skillful exploitation of the terrain. Effort should be invested in combining this method with other measures of deception and jamming. Examples might include combining with radar countermeasures, remote control measures, aeronautical radio jamming, the deployment of conventional pseudo targets, artificial fog and chaff dispersal, exploitation of error sources affecting barometric height and meteorological or geographical features. Manipulation has to be coordinated with the deployment of one's own forces.

To avoid feedback from the emitter site to the receiving site it is useful to introduce small controlled frequency shifts or phase shifts to the emitted signal.

Rapid surveying by means of satellite-assisted location-finding, even when movement is involved, is of importance for artillery purposes. Manipulation of the enemy surveys may be of military interest. In connection with the laying or clearance of minefields, the manipulation of precise coordinates may be of military importance. In this way the locating of mine lanes could be made difficult or errors caused in mine-laying.

Beaming reconnaissance resources would enable their results to be connected with distorted site information and the value of the results to be diminished.

One field of application might be found in manipulating maritime navigation in certain narrow channels (natural, mine lanes), particularly if conventional navigational aids are canceled for military reasons (radar silence, elimination of buoys). It is also conceivable that the method could be employed against submarines and navy drones that seldom surface if these only carry out correction of inertial navigation systems at certain points. The satellite-controlled, precise navigation of enemy frogmen and small combat resources (speed boats) could be prevented.

The efficiency and effectivity of deceiving countermeasures can be increased if used in combination with conventional jamming techniques. By way of example, the transmitting site can utilize a switching transmitter which outputs a jamming pulse between periods of deception signal transmissions. The jamming pulse can be a continuous-wave signal, a noise-jamming signal, or any other conventional jamming signal known in the art. Alternatively, a number of conventional jamming transmitters can be positioned outside the deceiving zone created by the transmitting site.

One application might be as a permanent object protection of particularly endangered buildings in regions affected by war or civil war.

Factors that might have a restrictive effect on the proposed solutions are calibration processes with other navigation methods when calculating their accuracy, and plausibility checks carried out by personnel. However, this presupposes that the existence of manipulation is suspected or that detailed knowledge exists on the possibilities of manipulation.

If under certain circumstances it then becomes possible to recognize an emitted signal as not trustworthy, there will still be a partial effect in a reduction to simple noise-blanketing interference with a high degree of efficiency, because the signal parameters will be largely maintained.

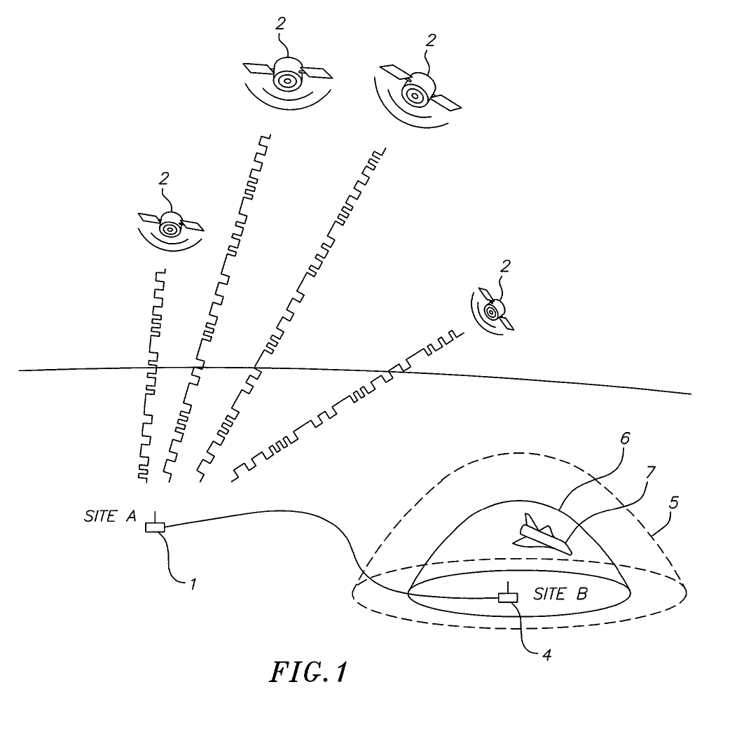

FIG. 1 is a schematic representation of the basic steps in a preferred embodiment of the present invention. At site A the signals of the visible and available satellites 2 are picked up in a receiving device 1 and transferred to site B by a transmission device 3. There they are emitted by a transmitting device 4. In a three-dimensional environment 6 the signal emitted by the transmitting device predominates so that a navigation receiver 7 located in this zone detects the site information of A. Surrounding this three-dimensional zone 6 with manipulated site information is a further interference zone 5, in which the satellite signals and the signal emitted by the transmitting device interfere to such an extent that no reliable site information can be obtained. The extension of the zones is also determined by the properties of the navigation receiver, influential factors include the geometry of the antenna and its location.

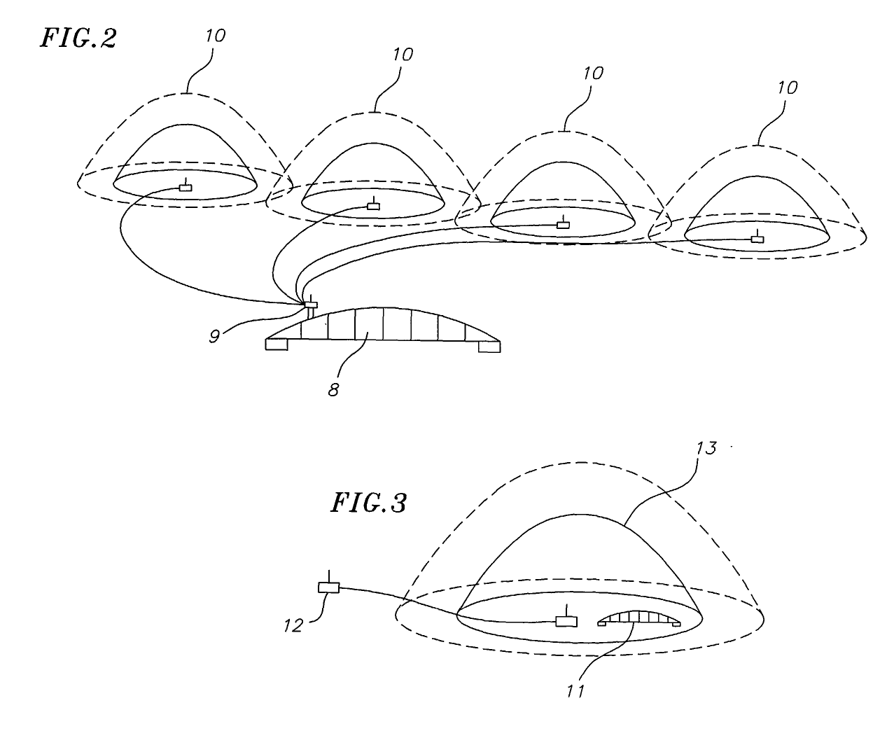

FIG. 2 demonstrates a possible application for generating pseudo-targets in schematic form. The signals are received at the object to be protected 8 with a suitable device 9. These signals are passed on and emitted at one or more other sites 10. A three-dimensional environment around the emitting sites have the same site information as the object to be protected. Particularly when this method is combined with other camouflaging and deception techniques it is possible for a pseudo-target to be mistaken for the object to be protected. The effectiveness of the enemy resources against the object under protection is thus diminished.

FIG. 3 is a schematic of the potential application of masking objects to be protected. At a site of minor enemy interest, the signals are received with a suitable device 12. These signals are passed on and emitted at another site so that an object to be protected 11 lies within the three-dimensional space 13 around the emitting site. The navigation receiver with means of attack or reconnaissance entering this space will obtain the same site information as for the less interesting site 12. Similarly, a combination with other techniques will prevent the enemy means of attack from finding the protected object precisely. A means of reconnaissance deployed assigns incorrect site information to the object being protected, which can lead to erroneous planning of an attack and reduction of the future risk, particularly if the masking is changed by moving the reception site 12.

One particular advantage of this application lies in the fact that even if the manipulation is recognized by certain future navigation systems, the satellite signal undergoes severe interference in the masked environment.

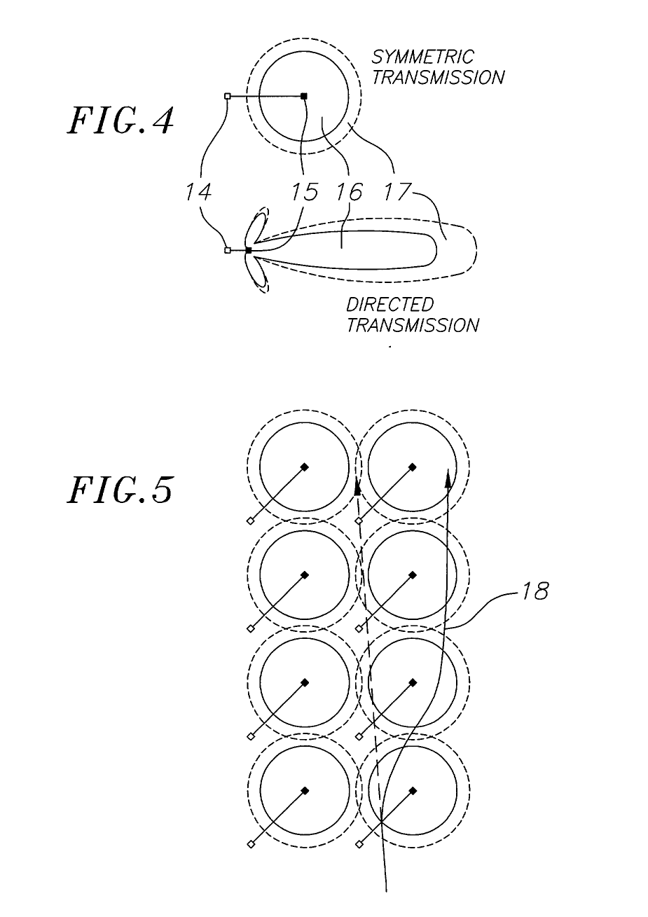

FIG. 4 shows the symmetrical and strongly asymmetrical arrangement of the emission environment in schematic form. The signals are picked up at the receiving site 14 and transmitted at the emitting site 15. The zone 16 affected by manipulation is depicted by a continuous perimeter line, it is generally surrounded by an interference zone 17 of imprecise location. The three-dimensional expanse depends upon the emitting geometry of the transmission antenna and the geographical characteristics of the surroundings. Asymmetric emission enables the route for the signal transfer to be kept small and the area affected by manipulation to be designed as large and directional. The zone with manipulation is drawn with a continuous perimeter. The signal receiver and the emission transmitter are indicated by small squares.

FIG. 5 depicts a simplified form of the principle for setting up a field of zones. In this way, severe, incorrect course corrections 18 can be induced in the enemy forces/resources using a series of manipulated geographical data. The zones in which the manipulated navigational information is detected are depicted by continuous perimeter lines. The locations of signal receiver and emitting device are indicated by a small square.

FIG. 6 depicts a simplified form of the principle for setting up a field of zones. The site information used to induce the course manipulation 19 is initially only slightly distorted and then more strongly distorted. This would enable a continuous drift to be simulated, which would create a more realistic illusion when compared with inertial navigation systems.

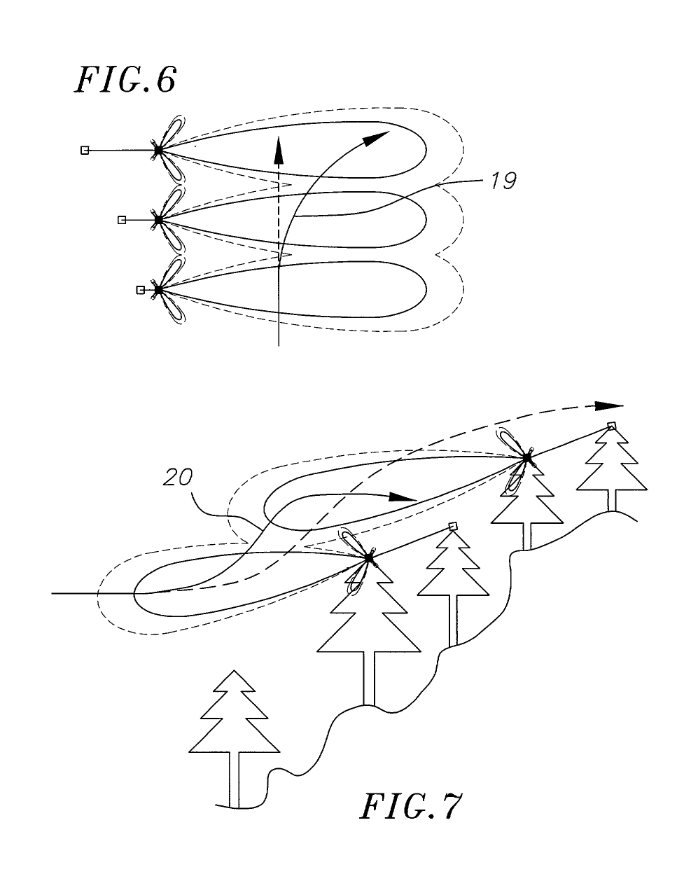

FIG. 7 depicts an application scheme for setting up a field of zones. The aim here is to induce a severe course manipulation 20 for a situation in which particular layouts of terrain obstruct a low-flying means of attack. In this case, also when further countermeasures are employed, it is possible to achieve considerable manipulation with the objective of causing a collision with the ground.

If during comparison with other means of measuring an altitude the coordinates are no longer trusted, there is still severe disruption of the satellite signals in the area affected by the emissions. In the terrain depicted in the sketch this could be critical or force the aircraft to rise above the reconnaissance horizon of its own air defense.

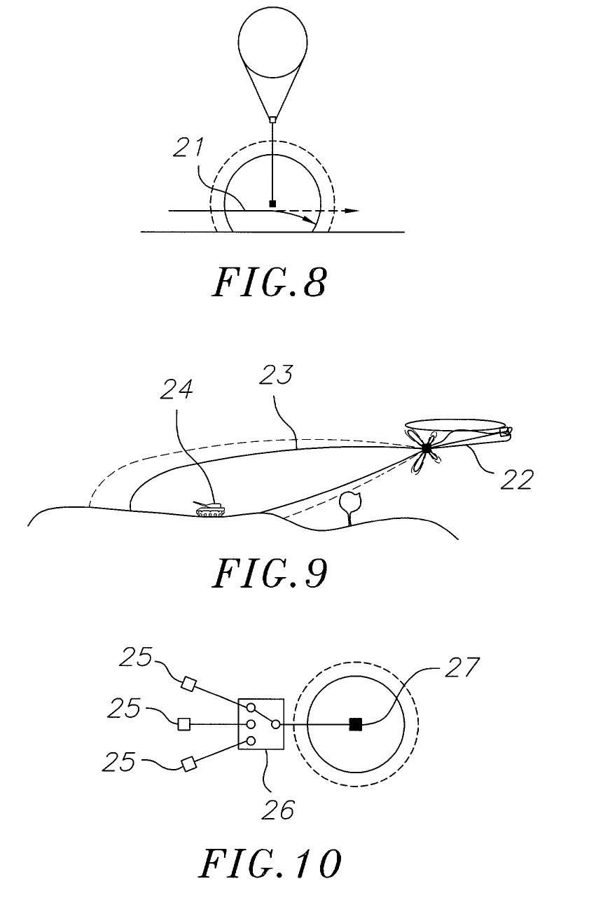

FIG. 8 presents a schematic representation for manipulating the altitude figures. Here the satellite signals are received in an aircraft or tall building and then fed on to be emitted in a lower-lying space. The effects of this manipulation may include causing the enemy's means of attack or reconnaissance to perform a critical course correction 21. Of further interest here is the beaming from above with a sharper angle of incidence than from the ground, this results in similar angles to that of the satellite being created.

FIG. 9 presents a schematic representation for manipulating surveying figures. Satellite signals are received by one's own forces 22, passed on and then emitted in a three-dimensional zone 23 with enemy forces 24. This could for an example result in an erroneous reading being taken for a launching position.

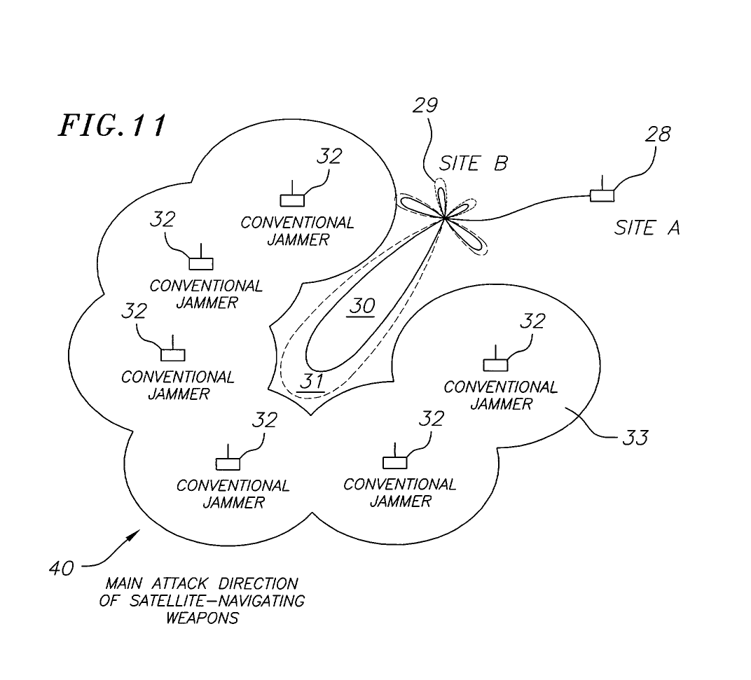

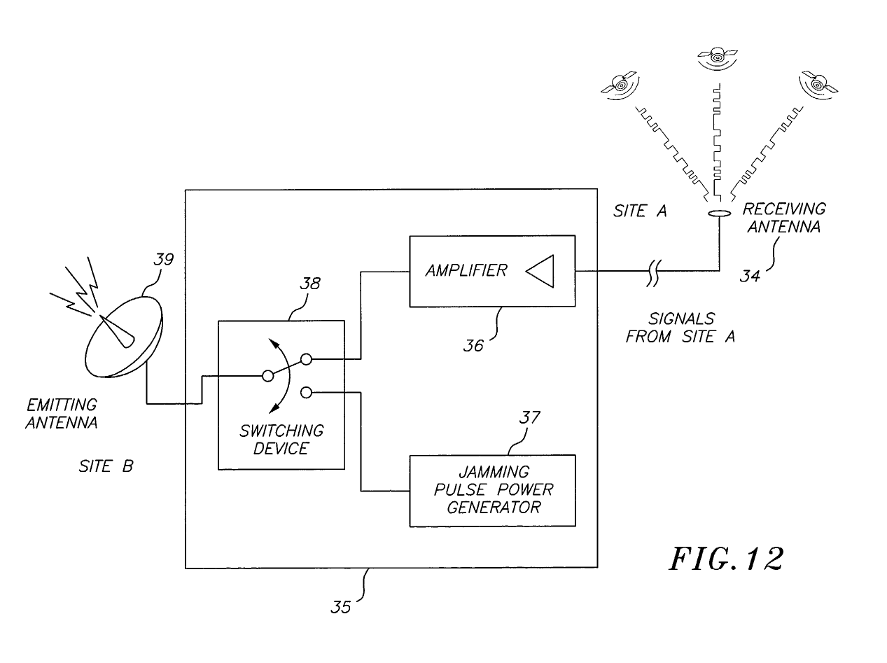

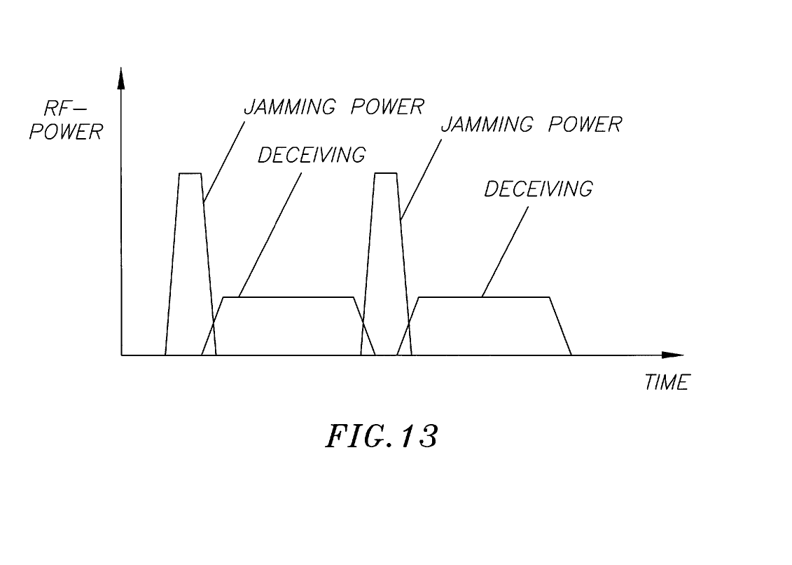

FIG. 10 shows a schematic representation employing an arrangement for switching between receiving sites 25. With the aid of a switching device 26 for the transmission lines to the emitting site 27 it is possible to continuously alter the manipulated coordinates. This might, for example, be interpreted as movement and thus improve the illusion created of moving objects.

FIG. 11 shows a schematic representation a preferred embodiment of the deceiving countermeasures in combination with conventional jamming techniques. The signals are picked up at the receiving site 28 and transmitted at the emitting site 29. In the described embodiment, a directional transmission antenna is used to generate an asymmetric deceiving zone 30. Surrounding the deceiving zone 30 is an interference zone 31 of imprecise location. A number of convention jamming transmitters 32 are strategically positioned outside the interference zone 31 to create a jamming zone 33. As a result, a satellite navigation weapons system 40 will first encounter jamming in route to its target thus facilitating the reacquisition of the satellite navigation weapons system 40 with the satellite signals in the deceiving zone 30.

Alternatively, the described deceiving countermeasures can be combined with conventional jamming techniques with a single transmitter. Referring to FIG. 12, satellite signals are received by a receiving antenna 34 and transferred to a transmitting device 35. In a preferred embodiment, the satellite signals received by the transmitting device 35 are coupled to an amplifier 36. The amplified satellite signals are then fed to one input of a switching device 38. A jamming pulse power generator 37 is connected the other input of the switching device 37. The output of the switching device 38 is toggled between the two input signals to time division multiplex the satellite signals from the receiving antenna with the jamming signal from the jamming pulse power generator 37. The time division multiplexed signal is coupled to an emitting antenna 39 for transmission into the deceiving zone.

FIG. 13 is an exemplary timing diagram showing a number of short jamming pulses interposed between deceiving signal transmissions. The actual timing of the time division multiplexed transmission will vary depending upon the particular application. Those skilled in the art will readily recognize that the timing of the time division multiplexed transmission can be varied by controlling the switching device 38 (See FIG. 12) with conventional techniques.

It is apparent from the foregoing that the present invention satisfies an immediate need for a method and apparatus which, instead of preventing the satellite signal from being received or evaluated by simple jamming, strives to alter the position fixed by satellite navigation in enemy navigation receivers from the true coordinates obtained without detectable intervention. This method and apparatus may be embodied in other specific forms and can be used with a variety of communications systems for both military and commercial applications without departing from the spirit or essential attributes of the present invention. It is therefore desired that the described embodiments be considered in all respects as illustrative and not restrictive, reference being made to the appended claims rather than the foregoing description to indicate the scope of the invention.

What is claimed is:

1. A method for deceiving a satellite navigation receiver, comprising:
receiving a satellite signal at a receiving site having first geographical coordinates;
providing the received satellite signal to a transmitting site having second geographical coordinates different from the first geographical coordinates; and
transmitting the received satellite signal from the transmitting site.

2. The method of claim 1 further comprising masking a target by locating the target within the second coordinates.

3. The method of claim 1 further comprising generating a pseudo target for the position of a target by locating the target within the first coordinates.

4. The method of claim 1 further comprising transmitting a jamming signal from within the transmitting site.

5. The method of claim 1 further comprising combining radar countermeasures with the transmission of the first coordinates from the transmitting site including transmitting remote control messages, artificial fog, or chaff dispersal from the transmitting site.

6. A system for deceiving a satellite navigation receiver, comprising;
a receiving site having first coordinates, the receiving site configured to receive a satellite signal; and
a transmitting site having second coordinates, the received satellite signal being provided to the transmitting site from the receiving site and being transmitted therefrom.

7. The system of claim 6 further comprising a target located within the second coordinates such that a navigation receiver does not detect the presence of the target when the navigation receiver is within the second coordinates.

8. The system of claim 6 further comprising a target located within the first coordinates such that a navigation detects the target when the navigation receiver is within the second coordinates.
